(19) United States
(12) Patent Application Publication
(10) Pub. No.: US 2025/0286097 A1
(43) Pub. Date: Sep. 11, 2025

(54) CELL FOR POWER GENERATION DEVICE, ASSOCIATED DEVICES AND METHOD

(71) Applicants: PARIS SCIENCES LETTRES, Paris (FR); ECOLE SUPERIEURE DE PHYSIQUE ET DE CHIMIE INDUSTRIELLES DE LA VILLE DE PARIS, PARIS (FR); CENTRE NATIONAL DE LA RECHERCHE SCIENTIFIQUE, PARIS (FR)

(72) Inventors: Annie COLIN, Bègles (FR); Youcef BRAHMI, PARIS (FR)

(21) Appl. No.: 18/292,627

(22) PCT Filed: Jul. 26, 2022
(86) PCT No.: PCT/EP2022/070961

§ 371 Date: Jul. 17, 2024

(30) Foreign Application Priority Data
Jul. 26, 2021 (FR) 2108113

(51) Int. Cl. H01M 8/18; H01M 8/0202; H01M 8/0289

(52) U.S. Cl. CPC H01M 8/188; H01M 8/0202; H01M 8/0289

(57) ABSTRACT

This relates to a cell for a power generation device, which includes: —two compartments intended respectively to receive fluids that each have a different concentration of a predetermined ion, which compartments are separated by a membrane allowing the predetermined ion to pass through; and —two adsorbent layers of the predetermined ion placed respectively on either side of the membrane. The invention also relates to two power generation devices incorporating such a cell, and to a method for operating one of these devices.

This application is the U.S. national phase of International Application No. PCT/EP2022/070961 filed Jul. 26, 2022 which designated the U.S. and claims priority to FR 2108113 filed Jul. 26, 2021, the entire contents of each of which are hereby incorporated by reference.

The present invention relates to the technical field of renewable energy production. It relates more particularly to a basic cell and two electricity production devices integrating this basic cell and making it possible to recover the energy of mixing a solution concentrated in ions and a solution less concentrated in these same ions.

It is known that mixing one cubic meter of sea water with one cubic meter of river water releases nearly 1 MegaJoule of mixing energy. The invention proposes an efficient means of collecting this natural energy.

In order to try to collect this energy, a first so-called “capacitive mixing” device is already known which comprises an electric cell formed of two capacitive (or super capacitive) electrodes which are, on one side, connected by an electrical circuit and, on the other side, immersed in a compartment comprising a fluid having a given concentration of a predetermined ion (generally a salt formed of a pair of predetermined ions). This device aims to collect electricity by varying, over time, the concentration of at least one ion of the fluid contained in the compartment. Thus, the operating cycle of such a device begins when the compartment is filled with a first fluid concentrated in the predetermined ion, and then comprises four phases: during the first phase, an electric current is applied in the electrical circuit and the cell is thus charged, during the second phase, the electrical circuit is opened and the first fluid in the compartment is replaced by a second fluid less concentrated in the ion, during the third phase, the electrical circuit is closed and the cell is discharged into the electrical circuit, and, during the fourth phase the electrical circuit is opened and the second fluid in the compartment is again replaced by the first fluid concentrated in the ion. Thus, by using an alternation of concentrated fluid and less concentrated fluid in ion in the compartment of the device, an oscillating capacitive current is generated by the device in a resistance placed on the electrical circuit, which makes it possible to collect electricity.

A second device called “reverse electrodialysis” is also known which comprises, on one hand, a series of membranes selective for anions or cations, which successively and alternately separate compartments containing respectively a first fluid concentrated in a pair of predetermined ions or a second fluid less concentrated in this same pair of ions, and, on the other hand, a faradic type electrode in each end compartment, the electrodes being connected together by an electrical circuit. Under the effect of the ion concentration gradient between the different compartments, the ions migrate from the compartment with the least concentration of ions, through the selective membrane, towards the compartment with the most concentration of ions. Each membrane being selective for cations or anions, an ionic flow is established, which is then converted into electricity at the electrodes by a faradic reaction, for example by a redox reaction.

The maximum power supplied by the second device is given by

$$P = \frac{{NE}_{OCV}^{2}}{4 {R}_{i}} \qquad [ Math . 1 ]$$

where Eocv is the open circuit potential which is associated with the membrane potential, Ri the internal resistance of the cell and N the number of pairs of membranes contained in the device. However, the viscous losses due to the pumping of liquids inside the cell must be deducted from this maximum power, to predict the net power likely to be collected.

Although progress has been made to reduce the internal resistance Ri of the cell, neither of the two devices described above is entirely satisfactory insofar as the surface power densities that they respectively make possible to collect remain low, of the order of 0.1 to 0.2 W·m⁻² for the first capacitive mixing device and of the order of 1.5 W·m⁻² maximum for the second inverse electrodialysis device.

Therefore, there is a real need to improve these devices to recover more surface power density from the mixture of the first and the second fluid.

More particularly, according to the invention, we propose a cell for an electricity production device, comprising:
two compartments respectively intended to receive fluids each one having a different concentration of a predetermined ion, and separated by a first membrane allowing at least the predetermined ion to pass through, and
two adsorbent layers of the predetermined ion placed respectively on either side of the membrane.

The cell according to the invention combines a membrane which allows at least one predetermined ion to pass through, and two layers adsorbing this predetermined ion, placed on either side of the membrane, in each compartment. The adsorbent layers make it possible to increase the total open circuit potential of the cell which occurs in the mathematical formula previously stated, since the potential of each adsorbent layer is added to that of the selective membrane, which potential of each adsorbent layer depends on the concentration of ions adsorbed on the adsorbent layer. Thus, each adsorbent layer makes it possible to boost the potential of the selective membrane.

Thanks to the membrane and the two adsorbent layers, an initial potential difference naturally exists, initially, in the cell according to the invention. This potential decreases as the predetermined ion is exchanged across the membrane, until equilibrium is reached.

Furthermore, the potential of the cell being increased thanks to the adsorbent layers, it is possible to produce an electricity production device comprising a limited number of selective membranes, that is allowing at least one predetermined ion to pass through, for example comprising one or two membranes. Thus, it is also possible to take advantage of the potential of the electrodes of the electricity production device (which is divided by the number of membranes) in addition to that of the cell(s). Conversely, prior art devices use a large number of membranes connected in series, which reduces the potential of the electrodes.

In addition, the use of adsorbent layers on either side of the membrane alleviates the problems linked to the presence of divalent ions in the fluids used.

According to an advantageous characteristic of the cell according to the invention, the membrane is selective and only allows the predetermined ion to pass through. By “only”, we mean that it does not let any ion other than the predetermined ion pass through, or that it essentially lets the predetermined ion pass through with a tiny portion of other ions which can pass through it. The selective membrane makes it possible to improve the membrane potential, by specifically choosing the predetermined ion exchanged between the compartments. The membrane is preferably selective for the predetermined ion having the greatest difference in concentration between the two fluids.

According to another advantageous characteristic of the cell according to the invention, each adsorbent layer has a thickness of between 50 and 500 micrometers. This range of thickness promotes good adsorption of ions on the surface of the adsorbent layer, without hindering the circulation of fluid in each compartment.

According to another advantageous characteristic of the cell according to the invention, each adsorbent layer is porous to the fluid of each compartment. Thus, the fluid contained in each compartment can pass through the adsorbent layer and come into contact with both the adsorbent layer provided in this compartment and with the membrane separating the two compartments.

According to another advantageous characteristic of the cell according to the invention, each adsorbent layer is electroconductive. This guarantees good electrical conduction of the cell.

According to another advantageous characteristic of the cell according to the invention, the adsorbent layer includes carbon nanotubes which promote electro-conductivity. Carbon nanotubes are easily found commercially and are easy to handle.

According to another advantageous characteristic of the cell according to the invention, each adsorbent layer comprises activated carbon to adsorb the predetermined ion, in particular a predetermined cation, for example the sodium ion Nat. Activated carbon is easily found commercially and its uses are known, so that depending on the desired adsorption it is easily adjustable.

According to another advantageous characteristic of the cell according to the invention, each adsorbent layer comprises graphene treated to adsorb a predetermined anion, for example the Cl⁻ ion.

According to another advantageous characteristic of the cell according to the invention, the distance between each adsorbent layer and the corresponding membrane is less than or equal to 100 micrometers. The effect of the adsorbent layers on the doping of the membrane potential is all the more important as this distance is minimized since a less distance is associated with a lesser ionic resistance. According to an advantageous variant, the adsorbent layer is directly formed on the membrane.

Such a cell according to the invention is suitable for use in a first device of the capacitive mixing type or in a second device of the inverse electrodialysis type. The invention therefore also relates to these first device and second device, including the cell according to the invention.

The invention thus relates to a first electricity production device (of the capacitive mixing type) comprising:
a cell according to the invention, and
a current collector in each compartment of the cell, located at a distance from the corresponding adsorbent layer, and separated from the latter by a porous and deformable material ensuring electrical contact between the adsorbent layer and the corresponding collector.

Thanks to the cell according to the invention, this first device has better efficiency in surface power density than the existing capacitive mixing devices.

According to an advantageous characteristic of the first device according to the invention, the first device comprises a first circuit for supplying a first fluid concentrated in the predetermined ion, a second circuit for supplying a second fluid less concentrated in the predetermined ion, and at least one permutation means for choosing which power circuit supplies each compartment of the cell. This arrangement makes it possible to independently modulate the fluid flow rates in each compartment. In addition, this arrangement makes it possible to simply and quickly swap the fluid to be circulated in each compartment.

According to another advantageous characteristic of the first device according to the invention, the collectors are tightened towards each other by a screw clamping means, each clamping element of which is tightened with a moment of between 1 and 5 Newton-meters. This tightening moment guarantees the proximity between each adsorbent layer and the membrane, without hindering the circulation of the fluid in each compartment.

According to another advantageous characteristic of the first device according to the invention, each collector comprises a capacitive electrode or a faradic electrode. Capacitive electrodes make it possible to directly collect electric current, without using a chemical reaction. Thus, these electrodes make it possible to directly transform the ionic current into electric current, without any additional step.

The invention also relates to a second electricity production device (of the inverse electrodyalysis type) which comprises:
a sequence of at least two cells according to the invention having a common compartment, the first cell being selective for a first predetermined ion and the second cell being selective for a second predetermined ion of polarity opposite that of the first ion, so that, on the one hand, two adjacent compartments are intended to respectively receive fluids each having a different concentration of a salt comprising the first and the second ion, and, on the other hand, the compartments of the first cell are separated by a first membrane allowing at least the first predetermined ion to pass through and the compartments of the second cell are separated by a second membrane allowing at least the second ion to pass through, and,
a current collector in each end compartment, located at a distance from the corresponding adsorbent layer, and separated from the latter by a porous and deformable material ensuring electrical contact between the adsorbent layer and the corresponding collector.

Thanks to the cell according to the invention, this second device has a better efficiency in surface power density than existing inverse electrodyalysis devices.

The second device thus comprises at least two cells with a common compartment, so that it comprises at least three compartments separated overall by two membranes. Of course, the number of cells contained in the second device according to the invention can be much greater than two, and can easily go up to 100 or even more. It must be understood that when the second device comprises more than two cells, then two adjacent cells always have one compartment in common, each one of the two adjacent cells being respectively selective for cations or selective for anions.

According to an advantageous characteristic of the second device according to the invention, each collector comprises a faradic electrode chosen from: an electrode whose metal participates in the redox reaction or an inert electrode placed in an electrolyte solution which contains a couple redox. Faradic electrodes allow the ionic current to be transformed into an electric current, via a chemical reaction.

According to another advantageous characteristic of any of the first device or the second device according to the invention, the device comprises at least one pump for circulating each fluid in each compartment. The pump allows the circulation rate of each fluid in each compartment to be precisely adjusted.

According to another advantageous characteristic of any of the first device or second device according to the invention, the device further comprises an electrical circuit connecting the collectors and to which a resistor is connected. It is through the resistance that the electrical power is collected.

The invention finally relates to a method of operating the first electricity production device according to the invention. More precisely, the invention relates to a method of producing electricity according to which:
a fluid concentrated in the predetermined ion is put into circulation in the first compartment of the first device according to the invention and a fluid with a low concentration of the predetermined ion is put into circulation in the second compartment of this device,
an electric current is generated in an electric circuit connecting the collectors, through a resistance connected to said electric circuit,
to continue to generate electric current the fluid concentrated in the predetermined ion is put into circulation in the second compartment while the fluid with a low concentration of this ion is put into circulation in the first compartment.

In practice, each compartment thus alternately receives the fluid concentrated in the predetermined ion and then the fluid less concentrated in this ion, and so on. An electric current is generated due to the difference in concentration of the predetermined ion between the two fluids separated by the membrane and the adsorbent layers. As the predetermined ion is exchanged across the membrane from the more concentrated fluid to the less concentrated fluid, the generated current decreases. The alternation of supply of each fluid to the compartments is implemented to prevent the electric current generated by the exchange of ions at the membrane from decreasing below a certain chosen value. The fact of permuting the fluids received in each compartment makes it possible to increase the electric current again, which electric current then ends up decreasing again when the difference in concentration of the predetermined ion diminishes between the two fluids received in the compartments. And it is then necessary to again permute the fluids received in each compartment.

Unlike the operating methods of known capacitive mixing devices, which require an initial phase of charging the collectors to generate an initial potential difference, the method of producing electricity according to the invention does not require any initial charging of the collectors since the cell naturally presents a potential difference between its compartments, separated by the membrane and the adsorbent layers. From an energy point of view, this is very advantageous since no electrical energy is initially lost in the method according to the invention.

According to an advantageous characteristic of the method according to the invention, the period of alternation of circulation of the respectively concentrated and slightly concentrated fluids is between 1 and 300 seconds, and the flow rate of circulation of the fluids is between 0.10 and 100 milliliters per second. These ranges of flow rates and alternation make it possible to recover maximum power in a minimum of time, taking into account a chosen useful surface area of a specific membrane, here between 1 and 5 cm², for example of the order of 2.2 cm².

Of course, the different characteristics, variants and embodiments of the invention can be associated with each other in various combinations as long as they are not incompatible or exclusive of each other.

In addition, various other characteristics of the invention emerge from the appended description made with reference to the drawings which illustrate non-limiting forms of embodiment of the invention and where:

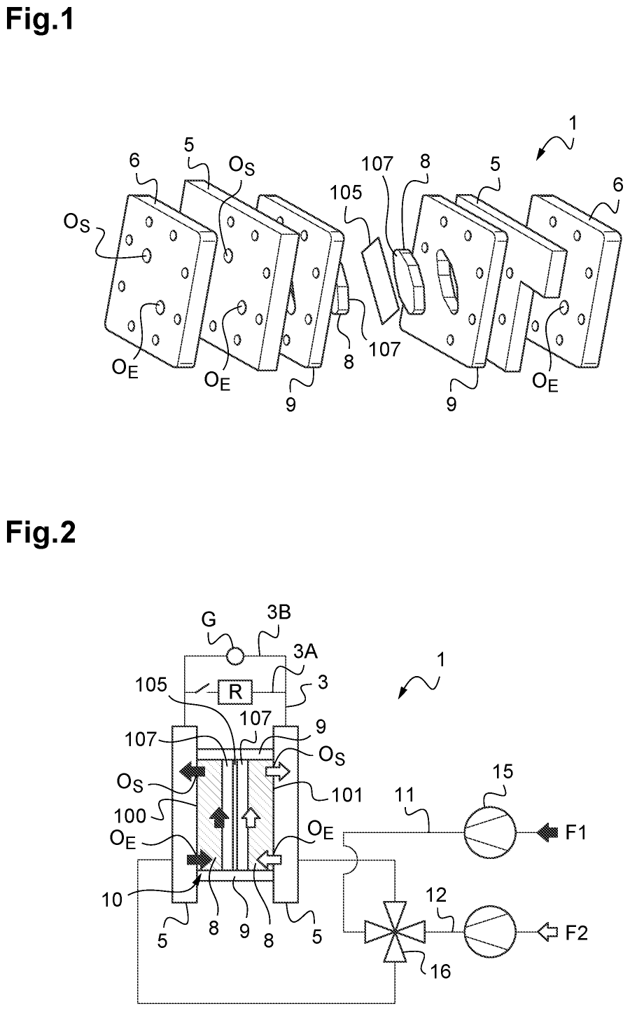

FIG. 1 is a schematic representation as an exploded view of a first electricity production device according to the invention,

FIG. 2 is a schematic sectional representation of the device of FIG. 1,

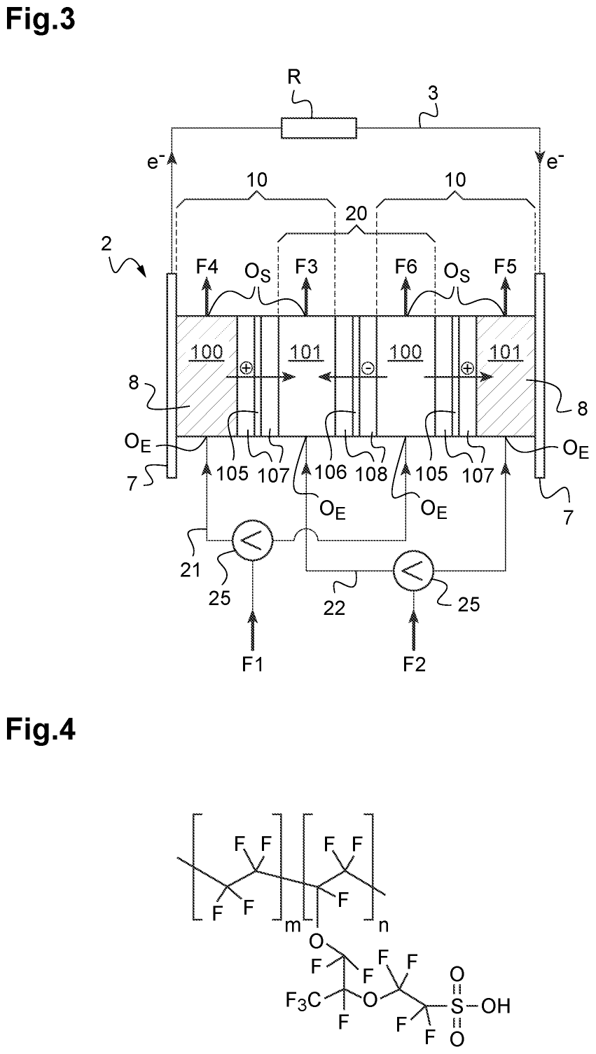

FIG. 3 is a schematic sectional representation of a second electricity production device according to the invention,

FIG. 4 is the representation of a chemical molecule used in a selective membrane of the Nafion™ 211 type,

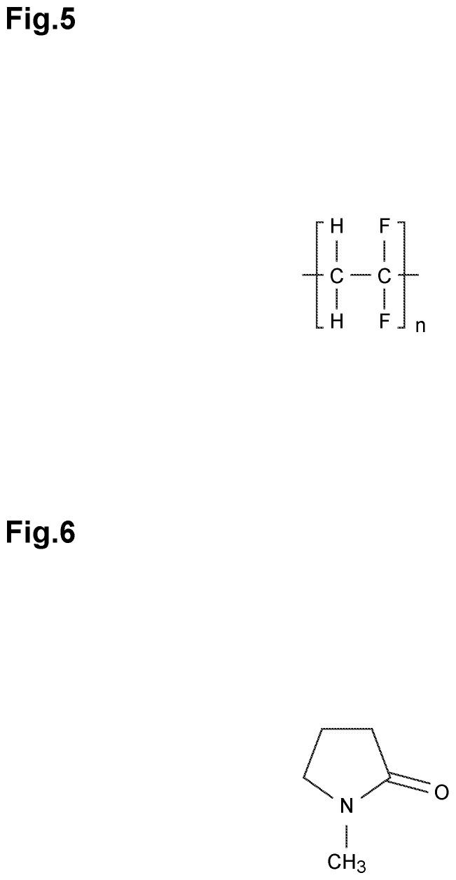

FIG. 5 is the representation of the fluorinated polyvinylidene polymer,

FIG. 6 is the representation of the N-methyl-2-pyrrolidone molecule,

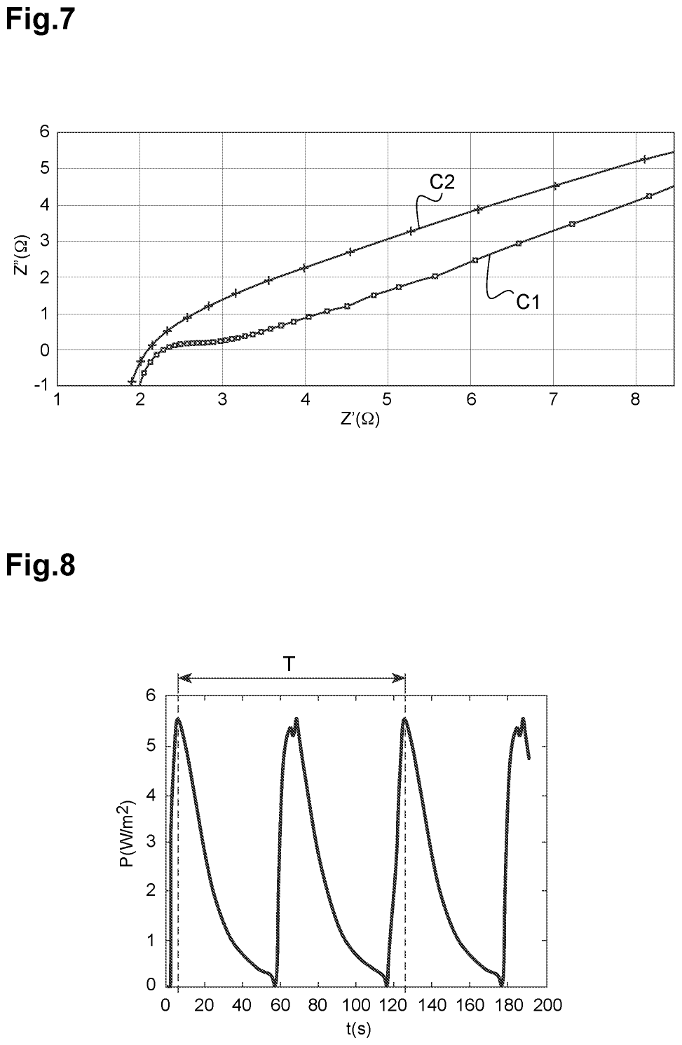

FIG. 7 is a graphic representation comparing the opposite of the imaginary part −Z″ of the internal impedance Z (in Ohm Ω) of a first device according to the invention (curve C1) and the opposite of the imaginary part −Z″ of the internal impedance Z (in Ω) of a comparative device (curve C2) as a function of the real part Z′ of the impedances Z (in Ohm) of these respective devices,

FIG. 8 is a graphical representation of the instantaneous power surface density P (in W/m²) measured in the first device according to the invention, as a function of time t (in seconds),

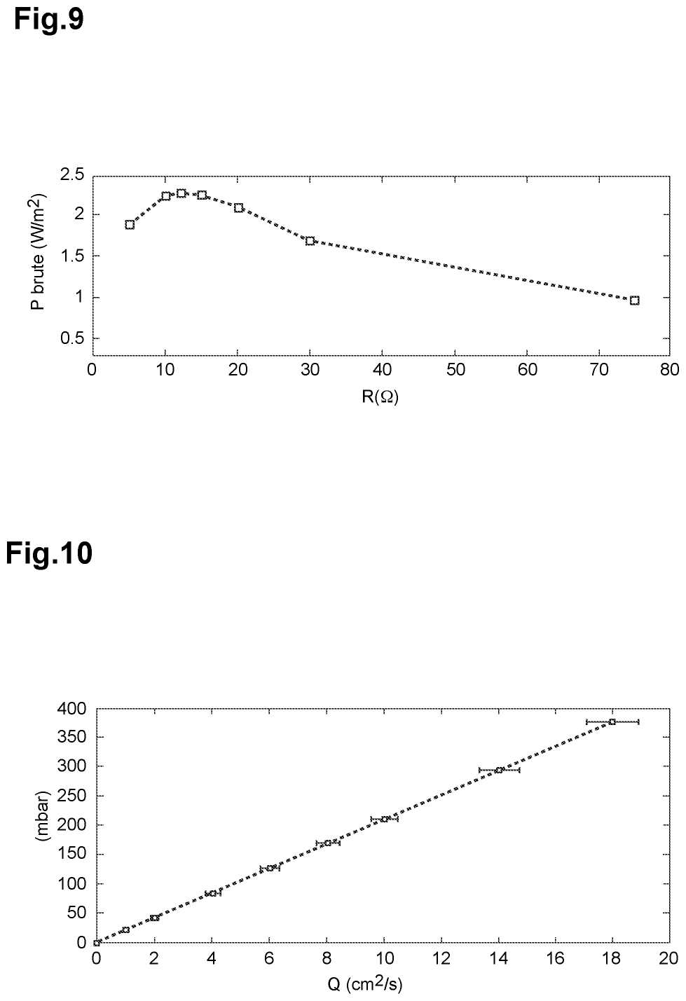

FIG. 9 is a graphical representation of the average raw power surface density Pbrute as a function of the resistance R (in Ohm Ω) provided on the electrical circuit of the first device according to the invention,

FIG. 10 is a graphical representation giving the pressure losses (given in mbar) in the device according to the invention, as a function of the fluid flow rate Q in the compartments of the device (given in cm³/s), and,

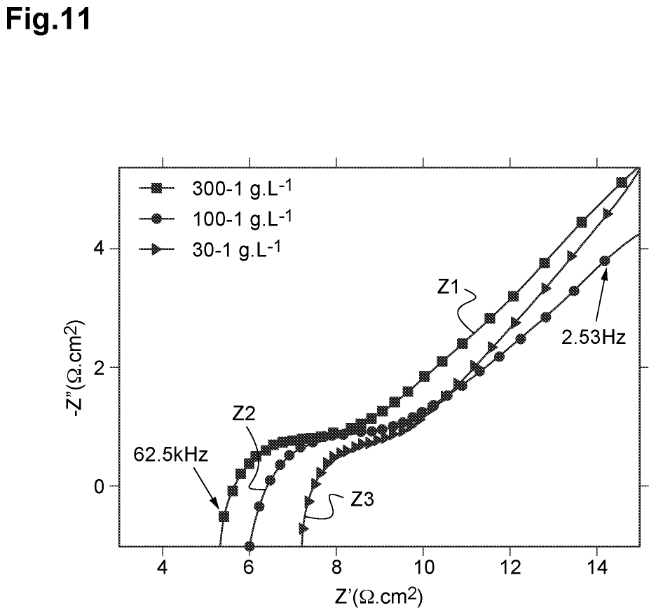

FIG. 11 is a graphic representation giving the opposite of the imaginary part −Z″ of the internal impedance Z (in ∩·cm²) of a first device according to the invention as a function of the real part Z′ of this impedance Z (in Ω·cm²), when the first device receives a first fluid concentrated at 300 g/l in sodium ion Na⁺ (curve Z1) or a first fluid concentrated at 100 g/l in sodium ion Na⁺ (curve Z2), or again a first fluid concentrated at 30 g/l in sodium ion Na⁺ (curve Z3), and a second fluid concentrated at 1 g/l in this same sodium ion Na⁺.

It has to be noted that, in these figures, the structural and/or functional elements common to the different variants may have the same references.

We have shown, on the one hand, in FIGS. 1 and 2, a first device 1 for producing electricity according to the invention, which is of the capacitive mixing type, and, on the other hand, in FIG. 3, a second device 2 for producing electricity according to the invention, which is of the reverse electrodyalysis type.

As shown in FIGS. 1 to 3, the two devices 1; 2 each integrate at least one cell 10; 20 according to the invention.

Cell 10; 20 according to the invention comprises more precisely:
two compartments 100, 101 intended respectively to receive a first fluid F1 and a second fluid F2, each one having a different concentration of a predetermined ion, separated by a membrane 105; 106 allowing the predetermined ion to pass through, and
two adsorbent layers 107; 108 of the predetermined ion, placed respectively on either side of the selective membrane 105; 106.

So, cell 10; 20 is a place where ions are exchanged, between the first and the second compartment 100, 101, through the membrane 105; 106, under the effect of a gradient of ion concentrations existing between the compartments.

Preferably, membrane 105; 106 used in the cell is selective for the predetermined ion, that is to say that it only allows this predetermined ion to pass through, and no other, or that it essentially lets pass through this predetermined ion and a tiny portion of other ions compared to the predetermined ion to which it is permeable. In the remainder of the description, we will therefore systematically speak of selective membrane 105; 106.

We will speak of a cationic cell 10 (or selective to cations) when the ion exchanged within the cell is a cation, for example the sodium ion Nat, while we will speak of an anionic cell 20 (or selective to anions) when the ion exchanged within the cell is an anion, for example the chloride ion Cl⁻.

Each compartment 100, 101 is intended to receive one of the first fluid F1 and the second fluid F2, preferably in circulation. In other words, each compartment 100, 101 has an inlet opening O_{E} through which the fluid enters the compartment 100, 101, and an outlet opening Os through which it exits the compartment 100, 101 (see FIGS. 1, 2 and 3). Each fluid is thus in movement in the corresponding compartment.

In practice, the first fluid F1 is for example sea water, concentrated in sodium chloride salt NaCl formed from the pair of ions Na⁺ and Cl⁻, and the second fluid F2 is for example fresh water of a river, less concentrated in this same salt. As a variant, it is possible that the first fluid F1 is formed of a brine from industry, very concentrated in certain ions, while the second fluid remains fresh river water with a low concentration of ions in a general manner, whatever they may be.

According to an advantageous characteristic of the invention, each adsorbent layer 107; 108 is porous to the fluid F1, F2 of each compartment 100, 101. Thus, the fluid F1, F2 contained in each compartment 100, 101 can pass through the adsorbent layer 107; 108 so that it comes into contact with both the adsorbent layer provided in this compartment 100, 101 and with the selective membrane 105; 106 separating the two compartments 100, 101.

The selective membrane is designed to allow a predetermined type of ion to pass through, in one direction or the other, that is to say towards one or towards the other compartment 100, 101. The direction of passage is solely determined by the balance of chemical potentials on either side of the membrane, which chemical potential depends on the difference in concentration of the predetermined ion between compartments 100, 101. Thus, the predetermined ion will circulate from the compartment the most concentrated in this ion towards the compartment the least concentrated in this ion.

More precisely, the membrane potential is linked to the existence of a charge gradient on either side of the membrane, and to the fact that the chemical potential of the ion which crosses the selective membrane must be equal on one side and the other of the selective membrane.

In the context of a selective membrane this potential is written:

$$E = α \frac{{R}_{g} T}{zF} log \frac{{a}_{H}}{{a}_{L}} \qquad [ Math . 2 ]$$

where Rg is the constant of ideal gases, T the temperature, F the Faraday number, a_{H} the chemical activity of the ions on the more concentrated side, a_{L} the chemical activity of the ions on the less concentrated side, z is the valence of ions and α is the permselectivity of the selective membrane.

Advantageously, the presence of the selective membrane 105; 106 and adsorbent layers 107; 108, generates an initial potential difference in the cell, as soon as the compartments 100, 101 are filled with the fluids F1, F2, solely due to the charge gradient.

A cationic selective membrane is for example a membrane of the perfluorinated type Nafion™ 211, marketed by Sigma Aldrich (CAS number 31175-20-9), which comprises a polymer formed from ethanesulfonic 2-[1-[difluoro [(1,2,2-trifluoroethenyl)oxy]methyl]-1,2,2,2-tetrafluoroe thoxy]-1,1,2,2-tetrafluoro-acid, the chemical formula of which is given in FIG. 4. Such a selective membrane is a selective membrane 105 which allows sodium Na⁺ ions to pass through. Such a selective membrane has a total acid capacity of between 0.95 and 1.01 meq/g.

Another example of a cationic selective membrane 105 is the Fumasep® FKS type membrane, marketed by the company Fumatech with SO₃⁻ groups also allowing Na⁺ ions to pass through.

An example of an anionic selective membrane 106 is the Fumasep® FAS type membrane with NR₃⁺ groups allowing Cl⁻ ions to pass through.

Preferably, the selective membrane 105; 106, whether cationic or anionic, has a thickness of between 10 and 50 micrometers (μm), for example of the order of 25 μm. This is a dry thickness, that is to say it corresponds to the thickness of the selective membrane 105; 106 before it is brought into contact with the fluids F1, F2. This membrane thickness is sufficient to allow good selectivity, without requiring too many materials for its manufacture.

Preferably, the average electrical conductivity of the selective membrane 105; 106 is greater than or equal to 0.1 S·cm⁻¹. We can consider that it is therefore a good conductor of current.

By adding adsorbent layers 107; 108 of the predetermined ion on either side of the membrane, the membrane potential E previously described is put in series with an own potential associated with the adsorbed layers.

The layer is called “adsorbent” in that it is capable of absorbing, that is to say retaining on its surface, by electrochemical interactions, the predetermined ion.

The adsorbent layer 107; 108 provided on either side of the selective membrane 105; 106 is identical. On the other hand, the adsorbent layer 107; 108 is chosen as a function of the selective membrane 105; 106 with which it is associated. Thus, the adsorbent layer 107; 108 specifically ensures the adsorption of the predetermined ion that the selective membrane 105; 106 lets pass through.

For example, the adsorbent layer 107 preferentially adsorbs the Nation when the selective membrane is cationic 105 and allows the sodium ion Na⁺ to pass through, while the adsorbent layer 108 preferentially adsorbs the Cl⁻ ion when the selective membrane is anionic 106 and lets the Cl⁻ ion pass through.

The adsorption characteristic of the adsorbent layer 107; 108 is for example obtained by means of activated carbon which has a large specific surface area and which makes it possible to adsorb the predetermined ion. The manner in which the carbon is activated determines which ion is adsorbed on the adsorbent layer 107; 108. For example, it is possible to easily adsorb cations, notably the sodium ion Na⁺ with activated carbon. The activation of the carbon is known in itself, and the nature of the adsorbed cation also depends on this activation.

According to a variant, the adsorption characteristic of the adsorbent layer is obtained by means of treated graphene, in particular to be able to adsorb anions, in particular the chloride ion Cl⁻.

The adsorption of the predetermined ion induces the appearance of a surface potential on the adsorbent layer 107; 108 which is a function of the surface charge of this adsorbent layer 107; 108. This surface charge is itself a function of the concentration of the predetermined ion adsorbed on the absorbent layer. Like the adsorbent layers 107; 108 adsorb the ion that the selective membrane lets pass through, the potential at the membrane is increased, so that the surface power capable of being recovered by the cell is also increased.

According to another characteristic of the invention, each adsorbent layer 107; 108 is electroconductive, that is to say current-conducting. This characteristic is for example obtained by carbon nanotubes included in the adsorbent layer and which promote its electro-conductivity. Alternatively, this characteristic is obtained by carbon black included in the adsorbent layer 107; 108. Thus, the adsorbent layer is also a good current conductor, which facilitates current recovery in the devices according to the invention.

Here, each adsorbent layer 107; 108 has a thickness of between 50 and 500 micrometers. This range of thickness promotes good adsorption of ions on the surface of the adsorbent layer, without hindering the circulation of fluid in each compartment. Preferably, the thickness is between 100 and 500 μm. More preferably, the adsorbent layer has a thickness of around 350 μm. The net power collected by the devices using cell 10; 20 according to the invention varies depending on this thickness.

Furthermore, preferably, the distance between each adsorbent layer 107; 108 and the corresponding selective membrane 105; 106 is less than or equal to 100 micrometers. This distance is of course filled with the fluid F1, F2 contained in the corresponding compartment. The closer the adsorbent layer 107; 108 is to the selective membrane 105; 106, the better the doping of the membrane potential will be. Indeed, the smaller the distance between the adsorbent layer and the membrane, the lower the ionic resistances in this zone. Moreover, it is entirely possible to form the adsorbent layers directly on the selective membrane.

Advantageously, the use of adsorbent layers 107; 108 on either side of the selective membrane 105; 106 alleviates the problems linked to the presence of divalent ions in the fluids F1, F2 used (in particular present in seawater) so that these ions do not disrupt the exchanges at the selective membrane.

Now that cell 10; 20 has been described, we will describe how it is used in the first device 1 according to the invention, and in the second device 2 according to the invention.

The first device 1 is of the capacitive mixing type and has only one cell, here the cationic cell 10.

The first device 1 also comprises a current collector 5 in each compartment 100, 101 of the cell 10, intended to collect the current generated by the ion exchanges within the cell 10.

More precisely, each collector 5 here comprises either a capacitive electrode or a faradic electrode.

Preferably, each collector of the first device comprises a capacitive electrode. In practice, such capacitive electrodes are known per se and do not constitute the heart of the invention. A capacitive electrode is for example formed from a mixture of carbon black or carbon nanotubes as an electrically conductive agent, a binder such as fluorinated polyvinylidene (or PVDF) whose chemical formula is given in FIG. 5, an active material such as activated carbon to ensure the adsorption capacity of ions (hence charges) and a solvent such as N-methyl-2-pyrrolidone (or NMP) whose chemical formula is given in FIG. 6.

A faradic electrode is an electrode whose metal participates in a redox reaction or an inert electrode placed in an electrolyte solution which contains a redox couple. For example, these may be silver/silver chloride (Ag/AgCl) redox electrodes or inert Ruthenium-Iridium (Ru—Ir) or Titanium-Platinum (Ti—Pt) electrodes. It can also be a carbon electrode placed in a rinsing electrolyte solution which contains a pair of ions participating in the same oxidation-reduction reaction, for example the Fe³⁺/Fe²⁺ couple, or the couple Fe(CN)₆³⁻/Fe(CN)₆⁴⁻.

As shown in FIG. 2, the collectors 5 are connected via an electrical circuit 3 which comprises two branches connected in parallel: a first branch 3A to which a resistor R is connected and a second branch 3B to which a current generator G is connected. In practice, we can very well do without the branch comprising the generator G. This generator is only present here to the extent that it is useful for carrying out certain tests on the first device 1, as it will emerge from the quantitative examples given below.

Here, each collector 5 has a single electrode. Alternatively, it is entirely possible to segment the electrodes, that is to say that each collector, or at least one of the collectors, comprises an electrode which is segmented into several pieces of electrodes.

Each collector 5 is located at a distance from the corresponding adsorbent layer 107 of the compartment 100, 101, and separated from the latter by a porous and deformable material 8 ensuring electrical contact between the adsorbent layer 107 and the collector 5.

Thus, the porous and deformable material 8 is interposed between the adsorbent layer 107 and the collector 5, that is to say in contact with the absorbent layer 107 on one side and in contact with the collector 5 on the other side. In other words, the porous and deformable material 8 is interposed, or sandwiched, between the adsorbent layer 107 and the collector 5. Here, the fact that the collector 5 is located “at a distance” from the adsorbent layer 107 means that the adsorbent layer 107 is not physically in contact with the collector 5. The adsorbent layer 107 and the collector 5 are thus disjointed.

As shown in FIG. 1, the porous and deformable material 8, the adsorbent layer 107 and the collector 5 extend here substantially parallel to each other. The porous and deformable material 8 here has the form of a layer extending substantially parallel to the adsorbent layer 107 and to the collector 5. The thickness of the porous and deformable material 8 is for example between 5 millimeters and 10 millimeters. Of course, the porous and deformable material 8 can have any suitable shape allowing it to ensure electrical contact between the adsorbent layer 107 and the collector 5 while separating them, that is to say here while making them disjoint.

The porous and deformable material 8 which ensures electrical contact between the adsorbent layer 107 and the collector 5 is for example a carbon felt or a carbon foam 8. The carbon felt comprises carbon fibers. For example, it is of the same type as those used in flowing batteries. Generally speaking, the porous and deformable material 8 is based on carbon to promote the transfer of electrons, and sufficiently porous to guarantee good circulation of the fluid in the compartment, with a minimum of resistance due to the circulation of the fluid (also called pressure loss or hydraulic pressure loss). Such a material ensures the transfer of electrons towards the collector 5. The fluid circulates through this material in the corresponding compartment 100, 101.

Here, the porous and deformable material 8 makes it possible to separate the selective membrane 105 from each collector 5 by a distance of between 5 and 10 millimeters, for example of the order of 6 mm. This distance allows sufficient fluid to circulate in the compartment to guarantee maximum ion exchange at the selective membrane 105; 106 without generating too much resistance due to the circulation of the fluid.

Here, the adsorbent layer 107 is manufactured directly on this porous and deformable material 8.

To do this, when the material is chosen to be carbon felt 8, a paste is prepared, then it is spread on one side of the carbon felt (the side which faces the selective membrane and which is intended to be attached to the latter).

The paste comprises, for example:
a solvent, for example N-methyl-2-pyrrolidone (or NMP), marketed by Sigma Aldrich,
10% carbon nanotubes (here those marketed by Sigma Aldrich under the name CNTs),
80% activated carbon (here that marketed by Sigma Aldrich under the name NORIT A SUPRA, with a BET specific surface area of 1700 m²·g⁻¹),
10% of a binder, for example fluorinated polyvinylidene (or PVDF, marketed by Sigma Aldrich), in mass relative to the total mass of the products added to the solvent.

The solvent is then evaporated so that only a dry layer remains on the carbon felt, here approximately 350 μm.

As has been said, it is also possible to form the adsorbent layer directly on the selective membrane, according to a principle similar to that described above, but with a different solvent. This alternative has the advantage of minimizing the distance between the selective membrane and each adsorbent layer, since in this case this distance is zero.

At the end of the formation of each adsorbent layer 107 on the corresponding carbon felt 8, each carbon felt 8 is inserted into a seal 9 which laterally borders the compartment 100, 101, so that the adsorbent layer 107 is in contact with the selective membrane 105 (see FIG. 1). The collectors 5 are then attached on either side of each carbon felt 8, against the seal 9 (see FIG. 1), and tightened towards each other by means of two stainless steel plates 6 and a clamping means (not shown). The clamping means here comprises clamping elements (not shown), for example nuts with bolts. The first device 1 comprises for example 8 clamping elements (see the circular locations intended to receive these clamping elements in FIG. 1). Here, each clamping element is tightened with a moment between 1 and 5 Newton meters (Nm), for example 2 Nm.

This tightening moment makes it possible to guarantee the spacing between each adsorbent layer 107 and the selective membrane 105. Here the tightening leads to guaranteeing the distance of 100 μm or less between the adsorbent layer 107 and the selective membrane 105. In addition, the tightening prevents the selective membrane, which is flexible, from faltering too much. However, the tightening should not be too significant, otherwise there is a risk of compressing the porous and deformable material too much and preventing the circulation of the fluid within it.

At the end of tightening, the selective membrane 105 is separated from each collector 5 with a thickness of deformable material of between 5 and 10 millimeters (mm), for example 6 mm.

So that the compartments 100, 101 are respectively supplied with the first fluid F1 and the second fluid F2, the first device 1 further comprises a first supply circuit 11 intended to supply one of the compartments 100, 101 with the first fluid F1 concentrated in the predetermined ion, and a second supply circuit 12 intended to supply the other of the compartments 100, 101 with the second fluid F2 less concentrated in the predetermined ion (see FIG. 2).

Each supply circuit 11, 12 here comprises at least one pump 15 to circulate each fluid F1, F2 in each compartment 100, 101 (see direction of circulation according to the arrows in FIG. 2). It should be noted that since exchanges and adsorptions of ions take place within each compartment 100, 101 during the circulation of fluids F1, F2, the fluid F3, F4 which leaves each compartment 100, 101 is different from the fluid F1, F2 which entered it, in particular because its concentration of the predetermined ion is different.

The pump 15 makes it possible to precisely adjust the flow rate Q of circulation of the fluid F1, F2 in each compartment 100, 101.

The first device 1 also comprises at least one permutation means 16 for choosing which power supply circuit 11, 12 supplies each compartment 100, 101 of the cell 10. The permutation means 16 comprises for example a motorized or manual valve. It is thus possible to quickly and simply swap the fluid F1, F2 which enters the compartments 100, 101.

In practice, as shown in FIGS. 1 and 2, the valve 16 is provided upstream of each inlet opening O_{E} in the compartments 100, 101. Here, each inlet and outlet opening O_{E}, Os of each compartment 100, 101 are delimited in the collectors 5 and in the clamping plates 6 to allow the insertion of a pipe up to the carbon felt 8.

Furthermore, in a conventional manner in itself, the first device 1 according to the invention comprises, on each supply circuit 11, 12, upstream of the cell 10, a filtration membrane (not shown) which makes it possible to eliminate the too large and annoying particles of fluids F1 and F2 so that they do not block the selective membrane 105 nor the adsorbent layers 107.

The first device 1 according to the invention is put into operation according to an electricity production method according to the invention.

According to this electricity production method,
the first fluid F1 concentrated in the predetermined ion is put into circulation in the first compartment 100 of the first device 1 and the second fluid F2 with a low concentration of the predetermined ion is put into circulation in the second compartment 101 of this first device 1,
an electric current is generated in the electrical circuit 3 connecting the collectors 5, through the resistance R connected to said electrical circuit 3,
the first fluid F1 is put into circulation in the second compartment 101 while the second fluid F2 is put into circulation in the first compartment 100.

Of course, the first fluid F1 and the second fluid F2 are circulated throughout the process thanks to the respective pumps 15 provided on the supply circuits 11, 12. The circulation of fluid is switched between the first and second compartments 100, 101 thanks to the valve 16.

In practice, each compartment 100, 101 of the device thus alternately receives the fluid concentrated in the predetermined ion and then the fluid less concentrated in this ion. An electric current is generated due to the difference in concentration of the predetermined ion between the two fluids separated by the selective membrane 106 and the adsorbent layers 107. As the predetermined ion is exchanged through the selective membrane 105 to go from the most concentrated fluid to the least concentrated fluid, the generated current decreases.

It should be clearly understood that the method according to the invention therefore comprises two operating phases, a first phase when the first compartment receives the concentrated fluid and the second compartment receives the less concentrated fluid, and a second phase when the first compartment receives the less concentrated fluid and that the first compartment receives the more concentrated fluid. These two phases have to be repeated cyclically to continuously generate electric current through the resistance R.

The current generated by putting the first device 1 into operation is therefore an oscillating or alternating capacitive current, collected via the resistor R placed on the electrical circuit 3.

The alternation of supply of each fluid to the compartments is implemented to prevent the electric current generated by the exchange of ions at the membrane from decreasing below a certain value. The fact of permuting the fluids received in each compartment 100, 101 makes it possible to increase the electric current again, which electric current then ends up decreasing again when the difference in concentration of the predetermined ion diminishes between the two fluids received in the compartments.

In practice, the period of alternation of fluids in each compartment is adjusted so that the filling time of the compartment, that is to say the quantity V/Q where V is the volume of a compartment and Q the circulation rate of the fluid is smaller than said alternation period. When using multiple electrodes on the total cell (segmented system), the filling time is V/(QN), where N is the number of electrode segments. The flow rate Q is chosen so as to minimize hydrodynamic losses while allowing rapid exchange of ions at the adsorbent layer.

Hydrodynamic losses are lowest at low flow rates and ion exchanges are fastest at high flow rates. In other words, since the two phenomena (hydrodynamic losses and ion exchange) vary in opposite ways with the flow rate Q, the optimal flow range is determined to best optimize these two phenomena.

The flow rate Q of circulation of the fluids F1, F2 is fixed thanks to each pump 15. For example, in the case of an electrode 2 cm high in the first device according to the invention, the optimal flow rate Q is precisely 0.16 ml·s⁻¹. This flow rate increases proportionally to the width of the compartment, that is to say to the width of the selective membrane, the other geometric parameters remaining constant. It is for example between 0.10 and 100 milliliters per second, for a useful surface area of selective membrane 105 of between 1 and 5 cm², for example of the order of 2.3 cm². This circulation rate is a compromise which guarantees being able to exchange sufficient ions at the selective membrane, so as to obtain satisfactory electrical power over a fairly short period of time. This flow also makes it possible to minimize hydraulic pressure losses in each compartment of the cell, which exist in particular in the carbon felt.

For example again, with the flow rate range Q given previously, the period of alternation of circulation of the first fluid F1 and the second fluid F2 in the first and second compartments 100, 101 is between 1 and 300 seconds, when the selective membrane 105 has a useful surface area of between 1 and 5 cm², for example of the order of 2.3 cm². That time is sufficient to guarantee satisfactory ionic exchanges at the selective membrane, and to collect sufficient charges at the collectors.

The electricity production method according to the invention does not require any initial charge of the collectors 5 of the first device 1 since the cell 10 naturally presents a potential difference between its compartments, separated by the membrane and the adsorbent layers. From an energy point of view, this is very advantageous since no electrical energy is initially lost in the process according to the invention.

The second device 2 shown in FIG. 3 is of the reverse electrodyalysis type and comprises a plurality of cationic and anionic cells 10; 20 according to the invention, alternately.

More precisely, the second device 2 comprises a sequence of at least two cells 10; 20 according to the invention having a common compartment 101, the first cell 10 being selective for a first predetermined ion (for example a cationic cell) and the second cell 20 being selective for a second predetermined ion of polarity opposite to that of the first ion (for example an anion cell).

Thus, in the second device 2, two adjacent compartments 100, 101 are intended to respectively receive the first fluid F1 and the second fluid F2 each having a different concentration of a salt comprising the first and second predetermined ions.

The second device 2 thus comprises at least two cells 10; 20 with a common compartment 101, so that it comprises at least three compartments 100, 101, 100 separated overall by two selective membranes 105; 106, of opposite selectivity. Of course, the number of cells 10; 20 contained in the second device 2 according to the invention can be much more important than two, and can easily go up to 100 or even more. It must be understood that when the second device 2 comprises more than two cells, then two adjacent cells always have a common compartment, each of the two adjacent cells being respectively selective for cations or selective for anions.

As shown in FIG. 3, the second device 2 shown here comprises a total of three successive cells 10; 20, namely four compartments 100, 101, successively separated from each other by three selective membranes 105; 106. The compartments 100, 101 of the first cell 10 are separated by the first selective membrane 105 allowing the first predetermined ion to pass through (here by the cationic selective membrane), the compartments 101, 100 of the second cell 20 are separated by the second selective membrane 106 allowing the second ion to pass through (here by the anionic selective membrane 106), and the compartments 100, 101 of the third cell 10 are separated by another first cationic selective membrane 105. In other words, the second device comprises a first end compartment 100 separated from a second central compartment 101 by a cation-selective membrane 105 (here for Na⁺ ions), itself separated from a third central compartment 100 by an anion-selective membrane 106 (here for Cl⁻ ions) itself separated from a fourth end compartment 101 by a cation-selective membrane 105 (here for Na⁺ ions). The first cell 10 comprises the first and the second compartment 100, 101, the second cell 20 comprises the second and the third compartment 101, 100, and the third cell 10 comprises the third and the fourth compartment 100, 101.

The second device 2 further comprises a current collector 7 in each end compartment 100, 101.

More precisely, each collector 7 here comprises a faradic electrode chosen from: an electrode whose metal participates in the redox reaction or an inert electrode placed in an electrolyte solution which contains a redox couple. For example, these may be silver/silver chloride (Ag/AgCl) redox electrodes or inert Ruthenium-Iridium (Ru—Ir) or Titanium-Platinum (Ti—Pt) electrodes. It can also be a carbon electrode placed in a rinsing electrolyte solution which contains a pair of ions participating in the same oxidation-reduction reaction, for example the Fe³⁺/Fe²⁺ couple, or the couple Fe(CN)₆³⁻/Fe(CN)₆⁴⁻.

As shown in FIG. 3, the collectors 7 are connected to each other by an electrical circuit 3 to which an electrical resistance R is connected.

Each collector 7 is located at a distance from the corresponding adsorbent layer 107, and separated from the latter by a porous and deformable material ensuring electrical contact between the adsorbent layer and the corresponding collector.

According to the same principle as what has been described in the context of the first device 1, the porous and deformable material is based on carbon to promote the transfer of electrons, and sufficiently porous to guarantee good circulation of the fluid in the compartment, with a minimum of hydraulic pressure loss. Here, the collectors 7 are for example separated from the corresponding adsorbent layer 107 by a carbon felt or a carbon foam 8 which ensures the transfer of electrons to the collector 7.

As has already been described for the first device 1 according to the invention, the adsorbent layer 107 is here directly deposited on the carbon felt 8 of the end compartments 100, 101.

Although not shown here, each compartment 100, 101 includes a carbon felt which separates the selective membranes 105; 106 from each other. The carbon felt 8 inserted in one of the central compartments 100, 101 of the second device 2, thus comprises, on each one of these main faces, facing the selective membrane 105; 106, the absorbent layer 107; 108 which corresponds to this selective membrane 105; 106.

When the central compartments do not include carbon felt, the adsorbent layer 107; 108 should be deposited directly on the corresponding selective membrane 105; 106.

On the other hand, the second device 2 comprises, like the first device 1 according to the invention, a first and a second supply circuit 21, 22 for supplying each compartment 100, 101 with the first or the second fluid F1, F2. It should be noted that since ion exchanges and adsorptions take place within each compartment 100, 101 of each cell 10; 20 during the circulation of fluids F1, F2, the fluid F3, F4, F5, F6 which leaves each compartment 100, 101 is different from the fluid F1, F2 which enters there, in particular because its concentration in each of the first and second predetermined ions is different.

Each supply circuit 21, 22 is equipped with at least one pump 25 to circulate each fluid F1, F2 in each compartment 100, 101.

On the other hand, unlike the first device 1, the second device does not need permutation means to permute the fluids circulating in each compartment 100, 101. In fact, the same “fresh” fluid (i.e. having not yet undergone any ion exchange) permanently enters each compartment 100, 101 via the corresponding entrance OF.

Conventionally in itself, the second device 2 according to the invention also comprises, on each power supply circuit 21, 22, upstream of the cells 10; 20, a filtration membrane (not shown) which makes it possible to eliminate particles that are too large and annoying from the fluids F1 and F2 so that they do not clog the selective membranes 105; 106 nor the adsorbent layers 107; 108.

The second device 2 according to the invention is put into operation according to a conventional electricity production method of known inverse electrodyalysis devices.

According to this known electricity production method, each compartment is supplied with the first fluid F1 or the second fluid F2, two adjacent compartments, separated by the same selective membrane, not being supplied by the same fluid. Two flows of ions are thus generated by the concentration gradient between the compartments 100, 101: a flow of cations (here Na⁺ ions) is generated towards one of the end compartments 101, while a flow of the anions (here Cl⁻ ions) is generated towards the other end compartment 100, as shown by the arrows crossing the selective membranes in FIG. 3. The collectors 7 associated with these end compartments thus generate, due to the excess in cations (respectively the deficit in cations) an oxidation-reduction reaction aiming to restore the balance of charges in said end compartments 100, 101, which has the consequence of generating a flow of electrons (therefore an electric current) in the electric circuit 3, which electric current is recovered via the resistance R.

Now that the two devices 1, 2 according to the invention have been described as well as their respective modes of operation, we will endeavor to give a precise example of implementation of the first device 1 according to the invention and the results obtained which show that, thanks to the combination of the selective membrane 105 and the two adsorbent layers 107 on either side of this selective membrane 105, the membrane potential values have doubled or even more. This phenomenon occurs without major change in the internal resistance Ri of cell 10, said internal resistance Ri being essentially linked to the loss of hydraulic pressure due to the fluid circulating in the compartments. The obtained surface power density is greatly maximized (at least by a factor of 4) thanks to the cell according to the invention.

More precisely, in this example, we compare the results obtained for the first device 1 according to the invention, and for a capacitive mixing device, not including the adsorbent layers.

The device 1 according to the invention comprises, in this particular example: two compartments separated by a sodium ion-selective membrane of the Nafion™ 211 type, having a dry thickness of 25.4 μm, a useful surface area of 2.24 cm², an average conductivity of 0.1 S·cm⁻¹. Each adsorbent layer is deposited on the carbon felt, on either side of the selective membrane, according to the technique described above, and has a final thickness of 350 μm. The selective membrane is separated from each collector by a distance of 6 mm, and the tightening of the 8 nuts of the device is 2 N·m.

The comparative device is identical in every respect to device 1 according to the invention, except that it does not include the adsorbent layers on either side of the selective membrane.

We will compare the open circuit voltages Eocv of the selective membrane in the device according to the invention and in the comparative device. The results are given in the following table 1, knowing that the open circuit voltage Eocv is measured according to the following procedure: fluids whose concentration of sodium ion Na⁺ is different circulate in each compartment (the concentration is given in Mol/l), while the electrical circuit is closed. Then the electrical circuit is opened, so that the collectors are disconnected from each other, and the circulation of fluid in each compartment is reversed. The electric potential drop Eddp of the open circuit is measured using a potentiometer (VSP 200 Biologic). The open circuit voltage Eocv corresponds to the electric potential drop divided by two, according to the following equation.

$$Eocv = \frac{Eddp}{2} \qquad [ Math . 3 ]$$

TABLE 1

| | | | | Device 1 |
|---|---|---|---|---|
| | | | | according |
| | Concentration | | | to the |
| Concentration | of fresh | | Comparative | invention |
| of seawater | river water | Concentration | Device | Eocv |
| (Mol/l) | (Mol/l) | gradient | Eocv (mV) | (mV) |
| 5.1335 | 0.0017 | 3000 | 142 | 246.5 |
| 4.2779 | 0.0017 | 2500 | 134 | 244.5 |
| 1.7112 | 0.0017 | 1000 | 129.5 | 241 |
| 5.1335 | 0.0171 | 300 | 118 | 208.5 |
| 4.2779 | 0.0171 | 250 | 113.5 | 201.5 |
| 1.7112 | 0.0171 | 100 | 98 | 175 |
| 0.0171 | 0.0017 | 10 | 54.5 | 95 |
| 5.1335 | 1.7112 | 3 | 27 | 52.9 |

It turns out that the open circuit voltage Eocv (given here in millivolts) also corresponds to the sum of the membrane potential Em and the potential of the adsorbent layers El, according to the following equation.

$$Eocv = Em + El \qquad [ Math . 4 ]$$

Thus, it appears from Table 1 that, since the open circuit voltage is much higher in the case of device 1 according to the invention than in the case of the comparative device, the adsorbent layers make it possible to increase the overall open circuit potential, that means in some way to boost the membrane potential Em. This makes it possible to maximize the electrical power capable of being collected by the device according to the invention.

We also compare graphically (see FIG. 7) the internal impedance curves Z (in Ohm) obtained for the device according to the invention (curve C1) and for the comparative device (curve C2). More precisely, the curves shown in FIG. 7 give the opposite of the imaginary part Z″ of the internal impedance Z as a function of the real part Z′ of the internal impedance Z, for each device.

The internal impedance Z of each device is measured by electrochemical impedance spectroscopy measurement. This measurement consists of circulating, in each compartment of the device tested, at a constant flow rate of 0.16 ml·s⁻¹, a fluid whose sodium ion concentration Na⁺ is fixed: here, the two fluids used are respectively salt water concentrated in sodium Na⁺ ions at 300 g/l and fresh water concentrated in sodium Na⁺ ions at 1 g/l. The electrical circuit is opened until a stable state is obtained. Oscillating disturbances of 10 mV are then applied in open circuit, with a frequency spaced logarithmically from 200 kHz to 47.8 mHz.

It can be deduced from FIG. 7 that the device according to the invention behaves, from an electrical point of view, at low frequency, like a capacitor in series with a resistor. We also note that it is at low frequency that the internal resistance of the devices studied is the strongest.

It can also be deduced from this FIG. 7 that the internal resistance of the device is not affected by the presence of the adsorbent layers. On the contrary, we even note that the adsorbent layers limit the internal resistance of the cell.

FIG. 11 shows the internal impedances Z1, Z2 and Z3 in the first device according to the invention when this device receives:
a first fluid F1 concentrated at 300 g/l in sodium ion Na⁺ and a second fluid F2 concentrated at 1 g/l in this same sodium ion Na⁺ (curve Z1),
a first fluid concentrated at 100 g/l in sodium ion Na⁺ and a second fluid F2 concentrated at 1 g/l in this same sodium ion Na⁺ (curve Z2), or
a first fluid F1 concentrated at 30 g/l in sodium ion Na⁺ and a second fluid F2 concentrated at 1 g/l in this same sodium ion Na⁺ (curve Z3).

Thanks to FIG. 11, we note that the overall internal resistance Ri of the device is governed by the compartment containing the fluid least concentrated in sodium ions (here the compartment containing the second fluid F2 concentrated at 1 g/l), the ion concentration sodium Na⁺ of the other fluid having little influence on the internal resistance. Thus, the device according to the invention can receive first fluids very concentrated in ions, without impact on its internal resistance.

FIG. 8 shows the surface density of instantaneous electrical power P (in W/m²) obtained by the device 1 according to the invention, as a function of time t (in seconds) for supplying the device 1 with salt water concentrated in sodium Na⁺ ions at 300 g/l and fresh water concentrated in sodium Na⁺ ions at 1 g/l, with a period of alternation of fluids, between each compartment, set at 45 seconds, and for a resistance R being 12Ω provided in the electrical circuit.

As shown in FIG. 8, the device is capacitive so that, to recover current, it is necessary to alternate the supply of the compartments with each of the two fluids. The fluid alternation is carried out at a period equivalent to half of the period T read in FIG. 8. In other words, the period T corresponds to a total operating cycle of the process according to the invention, including the two phases, the first phase extending over a duration T/2 and the second phase over another duration T/2. Still in other words, the period of alternation of fluids between the first and the second compartment of the first device 1 according to the invention is carried out here every half-period T/2, that is to say every 60 seconds in this example.

The variation in surface density of average raw power Pbrute is given in FIG. 9, as a function of the resistance R provided in the electrical circuit. The average gross power surface density Pbrute corresponds to the average power surface density not corrected by power losses (here mainly hydraulic pressure losses) existing due to, on the one hand, the operation of the pumps making it possible to supply the compartments with the fluids, and, on the other hand, the resistance to the flow of the fluid in the porous material constituting the bulk of each compartment. In practice, FIG. 9 is obtained from the results of FIG. 8, considering that the average power surface density Pbrute is an average of the instantaneous voltage signal measured through the resistance R, over a period T. Thus, the average power density Pbrute is obtained from the following mathematical formula, where A is the useful surface of the selective membrane, T the period of the measured signal, ER the voltage across the resistance R in the electrical circuit 3 of the first device 1, and P the instantaneous power surface density.

$$Pbrute = \frac{1}{T \cdot A} {\int }_{0}^{T} \frac{{E}_{R}^{2} ( t )}{R} = \frac{1}{T \cdot A} {\int }_{0}^{T} P ( t ) \qquad [ Math . 5 ]$$

To obtain the surface density of the collected net power, it is necessary to subtract from the raw power surface density Pbrute previously obtained the lost power surface density used to power the pumps to circulate the fluids in the compartments of device 1. Therefore, it is appropriate to remove hydrodynamic losses, also called hydraulic pressure losses.

Hydrodynamic losses are measured by taking pressure drop measurements as a function of the fluid circulation rate (measurements shown in FIG. 10). To do this, a syringe is used to supply the compartment with fluid. A pressure drop is imposed between the top of the syringe and the compartment outlet, using a pressure controller (Fluigent). The maximum pressure applied by the controller is 700 mbar and the accuracy over the entire measuring range is 10 Pa according to the manufacturer's specifications. To correct the measurement of the pressure drop inside the syringe, the pressure drop is measured both on the assembly formed by the compartment, the tubing and the syringe, but also on the tubing and syringe alone, and the last measurement is subtracted from the first. Flow rate is measured by weighing the mass of electrolyte flowing from the compartment with a precision balance.

The surface density of lost power Pperte is found using the following mathematical formula, where Q is the flow rate of the fluids, A is the useful surface area of the selective membrane and Rh is the hydrodynamic resistance of device 1, equal to 205,93.107 kg·m⁴·s⁻¹ here.

$$Pperte = \frac{{RhQ}^{2}}{A} \qquad [ Math . 6 ]$$

We notice in FIG. 10 that the lower the flow rate, the lower the pressure drops, so that the associated surface density of lost power is itself reduced. This is the reason why, in the devices according to the invention, the fluid flow rate is preferably very low.

Here, the maximum net surface power density obtained for the example of the first device according to the invention is equal to 2 W·m⁻² for a fluid concentrated at 300 g/l and the other concentrated at 1 g/l, in sodium Na⁺ ions.

These values are obtained at room temperature and are significantly higher than those obtained with existing devices.

Other experiments were carried out in the same way, only varying the thickness of the adsorbent layer provided on either side of the selective membrane in the first device according to the invention. For an adsorbent layer having a thickness of 50 microns, the net power surface density obtained is 1 Watt per m² instead of 2 Watt per m². For an adsorbent layer having a thickness of 600 microns, the net power surface density obtained is 0.5 Watt per m². Thus, preferably, it is necessary to aim for a thickness of adsorbent layer making it possible to obtain a capacity of 1 Farad, which adsorbent layer must be as porous as possible for fluid exchanges and result in the overall minimum cell resistance.

The invention is particularly advantageous in that it could be easily implemented on an industrial scale, in particular by increasing the useful surface area of the selective membrane up to 100 cm² or even 1 m² and by increasing the volume of each compartment, as well as by increasing the number of first and second devices used.

In the case of industrial scaling, it is possible to provide liquid supplies over the entire height of the cell of the first or of the second device, that is to say to provide several O_{E} inlets distributed over the entire height of the compartment, and/or to enlarge the dimension of this or these inlets. The distance between the O_{E} inlets and the dimension of the O_{E} inlets impact the flow rates of fluid circulation and the alternation period of the fluids in the compartments, in the case of the first device. In particular, in the case of the first device, the quantity Va/Q, where Va is the volume of fluid between two inlets O_{E} and where Q is the flow rate of fluid, must be smaller than the alternation period of circulation of fluids in the compartments (equal to T/2 with reference to FIG. 8 for example). Typically for a compartment width (which corresponds to the useful surface area of the selective membrane) of 1 cm², inlets separated from each other by 2 cm and a compartment thickness (which corresponds to the distance separating the selective membrane and the collector) of 6 mm, the appropriate flow rates Q are between 0.1 and 0.5 ml·s⁻¹. This flow range is adapted proportionally as the compartment width or compartment thickness changes.

Of course, various other modifications can be made to the invention within the scope of the appended claims.

1. Cell for an electricity production device, comprising:
two compartments intended respectively to receive fluids, each one having a different concentration of a predetermined ion, separated by a membrane allowing at least the predetermined ion to pass through, and
two adsorbent layers of the predetermined ion placed respectively on either side of the membrane.

2. The cell according to claim 1, wherein the membrane is selective and allows only the predetermined ion to pass through.

3. The cell according to claim 1, wherein each adsorbent layer has a thickness of between 50 and 500 micrometers.

4. The cell according to claim 1, wherein each adsorbent layer is porous to the fluid of each compartment.

5. The cell according to claim 1, wherein each adsorbent layer is electroconductive.

6. The cell according to claim 1, wherein the distance between each adsorbent layer and the corresponding membrane is less than or equal to 100 micrometers.

7. Device for producing electricity comprising:
a cell according to claim 1, and
a current collector in each compartment of the cell, located at a distance from the corresponding adsorbent layer, and separated from the latter by a porous and deformable material ensuring electrical contact between the adsorbent layer and the corresponding collector.

8. The device according to claim 7, which comprises a first supply circuit with a first fluid concentrated in the predetermined ion, a second supply circuit with a second fluid less concentrated in the predetermined ion, and at least one permutation means for choosing which power supply circuit supplies each compartment of the cell.

9. The device according to claim 7, wherein each collector comprises a capacitive electrode.

10. Device for producing electricity which comprises:
a sequence of at least two cells according to claim 1 having a common compartment, the first cell being selective for a first predetermined ion and the second cell being selective for a second predetermined ion of polarity opposite that of the first ion, so that, on the one hand, two adjacent compartments of the device are intended to respectively receive fluids each having a different concentration of a salt comprising the first and the second ion, and, on the other hand, the compartments of the first cell are separated by a first membrane allowing at least the first predetermined ion to pass trough and the compartments of the second cell are separated by a second membrane allowing at least the second predetermined ion to pass through, and
a current collector in each end compartment, located at a distance from the corresponding adsorbent layer, and separated from the latter by a porous and deformable material ensuring electrical contact between the adsorbent layer and the corresponding collector.

11. The device according to claim 10, wherein each collector comprises a faradic electrode chosen from: an electrode whose metal participates in the redox reaction or an inert electrode placed in an electrolyte solution which contains a redox couple.

12. Method of producing electricity according to which:
a fluid concentrated in the predetermined ion is put into circulation in the first compartment of the device according to claim 7 and a fluid with a low concentration of the predetermined ion is put into circulation in the second compartment of this device,
an electric current is generated in an electric circuit connecting the collectors, through a resistance connected to said electrical circuit,
to continue to generate electric current the fluid concentrated in the predetermined ion is put into circulation in the second compartment while the fluid with a low concentration of this ion is put into circulation in the first compartment.

13. The cell according to claim 2, wherein each adsorbent layer has a thickness of between 50 and 500 micrometers.

14. The cell according to claim 2, wherein each adsorbent layer is porous to the fluid of each compartment.

15. The cell according to claim 2, wherein each adsorbent layer is electroconductive.

16. The cell according to claim 2, wherein the distance between each adsorbent layer and the corresponding membrane is less than or equal to 100 micrometers.

17. The cell according to claim 3, wherein each adsorbent layer is porous to the fluid of each compartment.

18. The cell according to claim 3, wherein each adsorbent layer is electroconductive.

19. The cell according to claim 3, wherein the distance between each adsorbent layer and the corresponding membrane is less than or equal to 100 micrometers.
